(19) United States
(12) Patent Application Publication
(10) Pub. No.: US 2026/0356412 A1
(43) Pub. Date: Nov. 12, 2026

(54) TROLLEY MECHANISM FOR SERVING FOOD AND DRINKS AND METHODS FOR USING SAME

(71) Applicant: PI-DESIGN AG, Baar (DE)

(72) Inventor: Jorgen Bodum, Küssnacht am Rigi (CH)

(21) Appl. No.: 19/486,966

(22) PCT Filed: May 21, 2024
(86) PCT No.: PCT/EP2024/063986

§ 371 Date: Nov. 24, 2025

(30) Foreign Application Priority Data
May 24, 2023 (DE) 102023113572.4

(51) Int. Cl. B62B 5/06

(52) U.S. Cl. CPC B62B 5/06; B62B 2202/67; B62B 2501/065

(57) ABSTRACT

The present invention relates to a structural element (10) for or of a support bar (22), comprising a trough-shaped wall (12) delimiting a hollow space (18), and a plurality of reinforcing ribs (19) arranged at least partially within the hollow space (18) and being connected to the wall (12). Moreover, the present invention is drawn to a support bar (22) comprising such a structural element (10) and to a trolley (30) for serving food and drinks comprising at least one such a structural element (10).

The present invention relates to a structural element for or of a support bar. Further, the present invention is drawn to a support bar comprising such a structural element and to a trolley for serving food and drinks comprising at least one such a structural element.

Trolleys for serving food and drinks are known for a long time and for example disclosed in DE 101 08 562 A1. They usually comprise a framework of support bars on which one or more functional elements such as castors, handles and the like are mounted. Moreover, one or more plates are provided on which the drinks or the food can be placed. The plates typically rest on the framework.

The framework is usually made of metal. As a result, the manufacture, in particular the large-scale production, of such trolleys is fairly cumbersome. Moreover, the weight of the trolley is relatively high which aggravates the handling of the trolley and increases the costs of the shipping.

It is therefore one task of one embodiment of the present invention to present a trolley and other products having a framework of support bars that can be produced in large-scale in an economical way and have a limited weight.

The task is solved by the features specified in claims 1, 10 and 16. Advantageous embodiments are the subject of the dependent claims.

One embodiment of the present invention relates to a structural element for or of a support bar, comprising
a trough-shaped wall delimiting a hollow space, and
a plurality of reinforcing ribs arranged at least partially within the hollow space and being connected to the wall.

The trough-shaped wall may have a curved cross-section like a C-shaped or a semi-circular cross-section. Alternatively, the trough-shaped wall may have a cross-section being formed at least partially by planar sections that form one or more edges. The reinforcing ribs are located at least partially within the hollow space that is defined by the wall. Thus, the structural element can be provided with a high stability without the need to provide the wall with a higher wall thickness and is thus lightweight. Beyond that, the hollow space is used for the arrangement of the ribs such that they do not take up space or take up only a small space outside the structural element. Therefore, the structural element is space efficient.

According to one embodiment of the present invention, the structural element is made of plastic that can be injection molded such that the structural element is made in one-piece. The fact that the wall is trough-shaped, it is open in one direction. Thus, it is possible to produce the structural element by injection molding as it can be removed from the mold. The use of plastic, in particular of a thermoplastic material, enables the manufacture of the structural element in large-scale at acceptable costs. Moreover, the use of plastic leads to a light construction such that the product that comprises the structural element according to this embodiment is lightweight. A lightweight product is generally easier to handle than heavy products. In many cases the shipping costs depend on the weight of the product to be transported. Thus, the shipping of a product comprising the structural element of the present embodiment is typically cheaper compared to heavier products.

In a further embodiment the hollow space is subdivided into a first half and a second half of equal size, wherein a first group of ribs is arranged in the first half and a second group of ribs is arranged in the second half. The number of ribs within one group can be randomly chosen and can be the same in the first group and the second group. The degree of symmetry within the structural element can thereby be enhanced. As mentioned, the structural element may be produced by injection molding. Usually, the higher the symmetry the more homogeneous the flow of the molten plastic into and inside the respective cavity. The formation of bubbles and sinkholes is thereby reduced leading to a higher quality and a higher stability of the final structural element.

In another embodiment the ribs protrude from the hollow space. The dimension of the ribs can be increased thereby also increasing the stability provided by the ribs.

Under another embodiment the ribs form a radially outwardly oriented extension. This extension also adds to the stability provided by the ribs.

According to a further embodiment the ribs form a cut-out or a hole. The cut-out or the hole can be used for fastening external parts to the structural elements, like castors, handles or the like without significantly compromising the stability provided by the ribs.

In another embodiment the structural element comprises reinforcing fins connected to the ribs. The fins provide additional stability to the structural elements.

In a further embodiment the structural element comprises connecting sections for connecting the structural element with another structural element. As will be explained later, it is possible to connect two of the present structural elements with each other such that they form a support bar or a support Strut. The connecting sections facilitate the connection of two structural elements with each other.

According to another embodiment the connecting sections comprise recesses or openings and complementarily formed protrusions. A snapping connection can thereby be provided by which it is particularly easy to connect two of the structural elements with each other without the need of specific tools. The available space within a shipping box can be used more efficiently such that small shipping boxes can be used which typically also reduces the costs of shipping.

Another aspect of the invention is directed towards a support bar comprising
a first structural element according to one of the preceding embodiments, and
a second structural element according to one of the preceding claims, and
the first structural element and the second structural element being connected to each other.

The technical effects and advantages as discussed regarding the present structural element equally apply to the support bar. Briefly, the support bar is compact, lightweight and offers a high stability. Moreover, it can be produced by injection molding which enables a large-scale production at acceptable costs.

In another embodiment the first structural element and the second structural element are identical to each other. It is not mandatory that the first structural element and the second structural element are identical. For constructional or design reasons, it may be advantageous that the first structural element is different from the second structural element. However, in case the first structural element and the second structural element are identical to each other, the production costs can be kept low, and the logistics can be facilitated as there is no need to monitor differently shaped structural elements.

A further embodiment is characterized in that the first structural element and the second structural element are connected to each other by means of a snapping connection. As mentioned earlier, the first structural element and the second structural element can be provided with recesses or openings and complementarily formed protrusions. For fastening the first structural element and the second structural element to each other the protrusions are introduced into the recesses or openings, thereby forming a snapping connection. The snapping connection is simple to manufacture and reliably fastens the first structural element and the second structural element to each other.

According to another embodiment the ribs are formed such that they abut on the wall of the other structural element. As mentioned earlier, the ribs can protrude from the hollow space. When a first structural element and a second structural element are connected to each other for forming the support bar, the ribs of the first structural element may protrude into the hollow space of the second structural element and vice versa. The ribs of one structural element can be dimensioned such that they abut on the wall of the other structural element of the support bar. The stability of the support bar is increased due to the contact of the ribs with the wall of the other structural element.

A further embodiment is characterized in that the support bar comprises at least one fastening section for fastening the support bar to other components. Other components could be further support bars, handles, castors or house walls, to name a few. Such fastening sections may provide a thread into which a threaded bar or a screw can be introduced. For this purpose a threaded sleeve or a nut may be arranged inside the support bar. The applicability of the support bar is thus increased.

An additional aspect of the present refers to a trolley for serving food and drinks, comprising at least one support bar according to one of the preceding embodiments.

The technical effects and advantages as discussed regarding the present structural element equally apply to the trolley. In particular, the trolley is lightweight and offers a high stability. As mentioned, the structural elements of the support bars of the trolley can be produced by injection molding which enables a large-scale production at acceptable costs.

According to another embodiment the trolley comprises at least one handle formed by one of the support bars. The handle of a trolley is usually not a load-bearing component and may therefore be made of a different material and have a simple design.

However, the support bar according to the present invention may also be used for the formation of a handle. The number of equal or similar parts can be kept high which is usually beneficial in terms of cost aspects.

In a further embodiment the trolley comprises at least one castor fastened to one of the support bars. Trolleys are typically equipped with castors for facilitating the movement from one location to another. As mentioned, the support bars of the trolley can be provided with fastening sections by which the castor can be fastened to the trolley. No additional fastening elements are needed, thereby keeping the number of parts low. However, the trolley could be provided without castor and would thus be embodied as a shelf or table.

The present invention is described in detail with reference to the drawings attached wherein

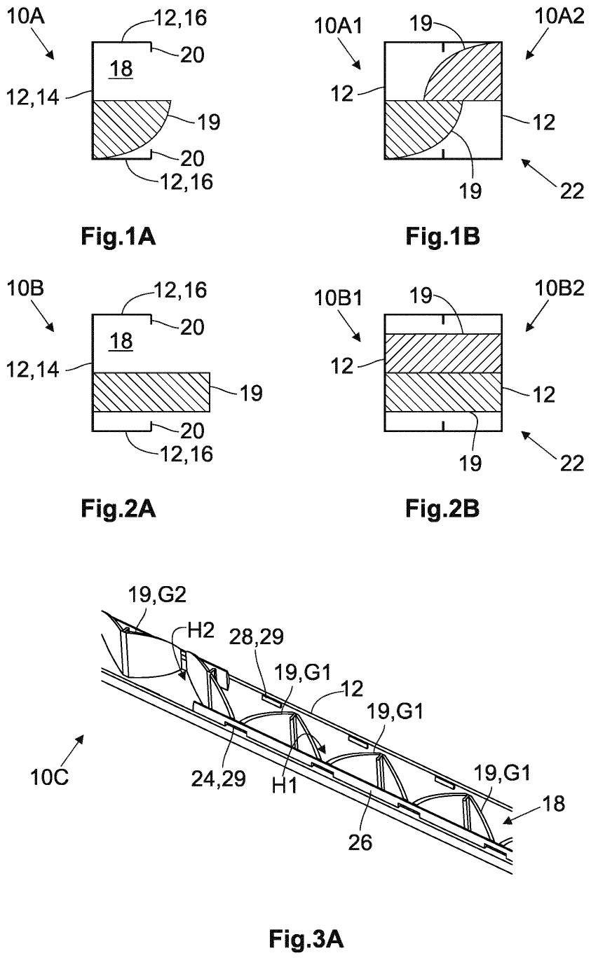

FIG. 1A shows a first embodiment of a structural element according to the present invention,

FIG. 1B shows a support bar comprising a first structural element and a second structural element as shown in FIG. 1A,

FIG. 2A shows a second embodiment of a structural element,

FIG. 2B shows a support bar comprising a first structural element and a second structural element as shown in FIG. 2A, all of them by means of principle sectional views,

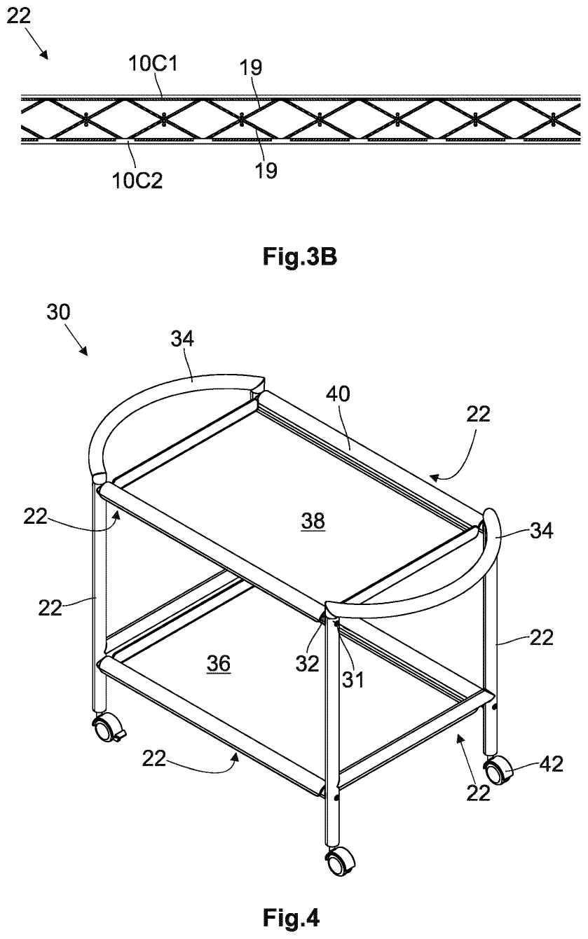

FIG. 3A is a perspective view of a third embodiment of a structural element,

FIG. 3B is a sectional view of a support bar comprising a first structural element and a second structural element as shown in FIG. 3A,

FIG. 4 is a perspective view of a trolley comprising a plurality of support bars shown in FIG. 3B.

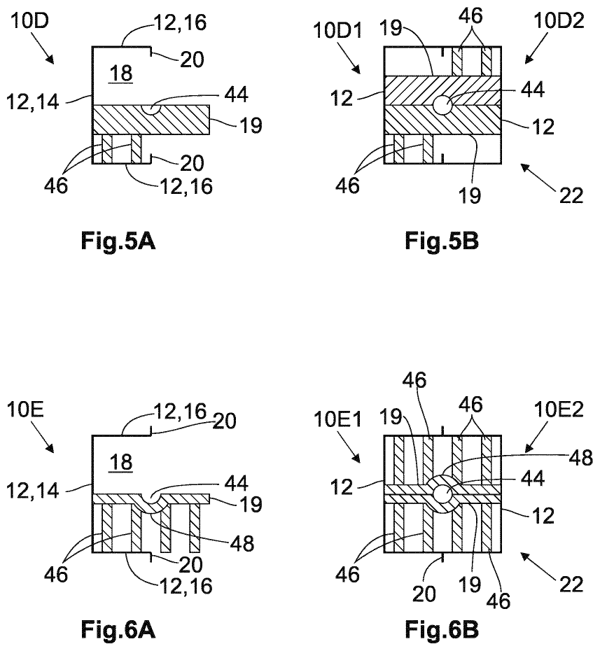

FIG. 5A shows a fourth embodiment of a structural element,

FIG. 5B shows a support bar comprising a first structural element and a second structural element as shown in

FIG. 5A, all of them by means of principle sectional views,

FIG. 6A shows a fourth embodiment of a structural element, and

FIG. 6B shows a support bar comprising a first structural element and a second structural element as shown in FIG. 6A, all of them by means of principle sectional views,

FIG. 1A shows a first embodiment of a structural element 10A according to the present invention by means of a principle sectional view. The structural element 10A comprises a trough-shaped wall 12 which in the first embodiment is formed by a first planar wall section 14 and two second planar wall sections 16 perpendicularly fastened to the first planar wall section 14. However, it should be noted that the wall 12 may also be curved. In any case, the wall 12 is open to one side and delimits a hollow space 18. The structural element 10A further comprises a plurality of reinforcing ribs 19 that are fastened to the wall 12. The ribs 19 are formed such that they are fastened to the wall 12 within the hollow space 18 and protrude from the hollow space 18. Moreover, the structural element 10A is provided with connecting sections 20 by which the structural element 10A can be connected to another structural element 10 (see FIG. 1B). In the first embodiment, the connecting sections 20 are formed by the wall 12 of the structural element 10. The connecting sections 20 form the free ends of the wall 12.

FIG. 1B shows a support bar 22 which comprises a first structural element 10A1 and a second structural element 10A2, both according to the first embodiment shown in FIG. 1A. The first structural element 10A1 and the second structural element 10A2 are connected to each other by means of the connecting sections 20 (see FIG. 1A). For connecting the first structural element 10A1 and the second structural element 10A2 with each other, they are arranged such that their connecting sections 20 are facing each other. For this purpose, the first structural element 10A1 and the second structural element 10A2 are turned relative to each other by 180° along their longitudinal axis (not shown, but runs perpendicular to the cutting plane of FIG. 1B).

As noted, the ribs 19 protrude from the hollow space 18. They are designed such that the ribs 19 of the first structural element 10A1 abut the ribs 19 of the second structural element 10A2 when connected to each other. The position of the first structural element 10A1 and the second structural element 10A2 relative to each other is thereby predefined. Beyond that, the rigidity of the support bar 22 is increased.

FIG. 2A shows a second embodiment of a structural element 10B according to the present invention. The structural element 10B of the second embodiment is to a large extend similar to the structural element 10A according to the first embodiment, so only the main differences are described in the following. The design of the rib 19 is insofar different as on its free end it forms a plane and protrudes from the hollow space 18 to a larger extent compared to the rib 19 of the first embodiment of the structural element 10A.

Turning to FIG. 2B, a support bar 22 is shown comprising a first structural element 10B1 and a second structural element 10B2 according to the second embodiment shown in FIG. 2A. Due to the differently shaped rib 19 there is not only a contact between the two ribs 19 of the first structural element 10B1 and the second structural element 10B2 as described for the first embodiment, but also a contact between the ribs 19 of the first structural element 10B1 and the wall 12 of the second structural element 10B2 and vice versa. To provide a fairly large contact area between the ribs 19 and the walls, the free end of the ribs 19 is formed complementary to the walls 12. The rigidity of the support bar 22 is thus further enhanced.

FIG. 3A is a perspective view of a third embodiment of a structural element 10C of the present invention. In this case the wall 12 has a semi-circular cross-section. Moreover, the hollow space 18 is subdivided into a first half H1 and a second half H2 of equal size, wherein a first group G1 of ribs 19 is arranged in the first half H1 and a second group G2 of ribs 19 is arranged in the second half H2.

The connecting sections 20 comprise openings 24 arranged within a wall extension 26 and further comprise complementarily formed protrusions 28 provided by the wall 12. For connecting two structural elements 10C to each other, the protrusions 28 of one structural element 10C are introduced into the openings 24 of another structural element 10C, thereby providing a snapping connection 29.

FIG. 3B shows a sectional view of a support bar 22 comprising a first structural element 10C1 and a second structural element 10C2 as shown in FIG. 3A. It is evident that the ribs 19 of the first structural element 10C1 abut on the ribs 19 of the second structural element 10C2 in the mounted state of the support bar 22.

FIG. 4 represents a perspective view of a trolley 30 that comprises in total six support bars 22 as shown in FIG. 3B. Two H-shaped support bars 22 are laterally arranged and are connected to each other by four horizontally running linear support bars 22. The H-shaped support bars 22 are made in one piece which means that the crossbar that connects the two sidebars does not have to be fastened to the latter. However, as evident from FIG. 4, the four horizontally running support bars 22 are fastened to the two H-shaped support bars 22 by means of screws 31 that are screwed into a fastening section 32 located inside the support bars 22. On the upper end the H-shaped support bars 22 are connected to handles 34 by which a user can maneuver the trolley 30. On the lower end a castor 42 is connected to the H-shaped support bars 22.

The four horizontally running support bars 22 are arranged pairwise and form a lower pair and an upper pair. A lower plate 36 is applied on the lower pair and an upper plate 38 is applied on the upper pair. The lower plate 36 and the upper plate 38 comprises embossments 40 by which they engage with the horizontally running support bars 22. Some of the support bars 22 are covered by the lower plate 36 and the upper plate 38 and are thus not or only partially visible in FIG. 4.

FIG. 5A shows a fourth embodiment of the structural element 10D by means of a principle sectional view. The structural element 10D is to a large extent similar to the second embodiment of the structural element 10B shown in FIG. 2A. However, the structural element 10D according to the fourth embodiment forms a cut-out 44 or hole. While the cut-out 44 may extend along the entire length of the structural element, the hole may only partially extend along the length of the structural element. The hole or cut-out 44 has the shape of a semi-circle. When two of the structural elements are connected to each other to form a support bar 22 as shown in FIG. 5B, a hole or cut-out with a circular cross-sectional shape is formed by which accessory parts like handles or castors (not shown) may be fastened to the support bar 22.

Moreover, the structural element 10D according to the fourth embodiment comprises two reinforcing fins 46 that are connected to the rib 19 and protrude therefrom to the second planar wall section 16. The rigidity of the structural element 10D and concomitantly of the support bar 22 is thereby increased.

FIG. 6A shows a fifth embodiment of the structural element 10E by means of a principle sectional view which is largely similar to the structural element 10D according to the fourth embodiment. However, the rib 19 forms a radially outwardly oriented extension 48 by which the rigidity of the rib 19 can be increased. Moreover, the extension 48 forms the cut-out 44 or hole as already mentioned. The cut-out 44 or hole is arranged in the center of the extension 48.

Beyond that, in total four reinforcing fins 46 are connected to the rib 19 and laterally protrude therefrom. However, only two of the fins 48 extend up to the second planar wall section 16. The remaining two fins 46 are designed such that they contact the second planar wall section 16 of the other structural element 10E2 when forming the support bar 22 as shown in FIG. 6B. The connecting section 20 is facing away from the hollow space 18 such that the fins 46 do not abut with the connecting section 20 when forming the support bar 22.

### REFERENCE LIST

10 structural element
10A structural element of a first embodiment
10B structural element of a second embodiment
10C structural element of a third embodiment
10D structural element of a fourth embodiment
10E structural element of a fifth embodiment
12 wall
14 first planar wall section
16 second planar wall section
18 hollow space
19 rib
20 connecting section
22 support bar
24 opening
26 wall extension
28 protrusion
29 snapping connection
30 trolley
31 screw
32 fastening section
34 handle
36 lower plate
38 upper plate
40 embossment
42 castor
44 cut-out, hole
46 fin
48 extension
G1 first group
G2 second group
H1 first half
H2 second half

1. A structural element for a support bar, comprising: a trough-shaped wall delimiting a hollow space, and a plurality of reinforcing ribs arranged at least partially within the hollow space and being connected to the wall.

2. The structural element according to claim 1, wherein the structural element is made of plastic that can be injection molded such that the structural element is made in one-piece.

3. The structural element according to claim 1, wherein the hollow space is subdivided into a first half (H1) and a second half (H2) of equal size, wherein a first group (G1) of ribs is arranged in the first half (H1) and a second group (G2) of ribs is arranged in the second half (H2).

4. The structural element according to claim 1, wherein the ribs protrude from the hollow space.

5. The structural element according to claim 1, wherein the ribs form a radially outwardly oriented extension.

6. The structural element according to claim 1, wherein the ribs form a cut-out or a hole.

7. The structural element according to claim 1, wherein the structural element comprises reinforcing fins connected to the ribs.

8. The structural element according to claim 1, wherein the structural element comprises connecting sections for connecting the structural element with another structural element.

9. The structural element according to claim 8, wherein the connecting sections comprise recesses or openings and complementarily formed protrusions.

10. A support bar, comprising
a first structural element, and
a second structural element claims,
wherein each structural element comprises a trough-shaped wall delimiting a hollow space and a plurality of reinforcing ribs arranged at least partially within the hollow space and connected to the wall, and wherein the first structural element and the second structural element are connected to each other.

11. The support bar according to claim 10, wherein the first structural element and the second structural element are identical to each other.

12. The support bar according to claim 10, wherein the first structural element and the second structural element are connected to each other by a snapping connection.

13. The support bar according to claim 10, wherein the ribs are formed such that they abut on the wall of the other structural element.

14. The support bar according to claim 10, further comprising at least one fastening section for fastening the support bar to other components.

15. A trolley for serving food and drinks, comprising at least one support bar comprising a first structural element and a second structural element, wherein each structural element comprises a trough-shaped wall delimiting a hollow space and a plurality of reinforcing ribs arranged at least partially within the hollow space and connected to the wall, and wherein the first structural element and the second structural element are connected to each other.

16. The trolley according to claim 15, wherein the trolley comprises at least one handle formed by one of the support bars.

17. The trolley according to claim 15, wherein the trolley comprises at least one castor fastened to one of the support bars.
